(19) United States
(12) Patent Application Publication
(10) Pub. No.: US 2026/0275008 A1
(43) Pub. Date: Sep. 17, 2026

(54) TRANSPARENT PVDF WITH SERVICE TEMPERATURE OVER THE MELTING POINT

(71) Applicant: Arkema Inc., King of Prussia, PA (US)

(72) Inventors: Azaz A. VAHORA, King of Prussia, PA (US); Florence MEHLMANN, King of Prussia, PA (US); James Joseph HENRY, King of Prussia, PA (US); Sara REYNAUD, King of Prussia, PA (US)

(21) Appl. No.: 19/168,417

(22) PCT Filed: Mar. 21, 2024
(86) PCT No.: PCT/US2024/020873

§ 371 Date: Sep. 24, 2025

Related U.S. Application Data
(60) Provisional application No. 63/454,777, filed on Mar. 27, 2023.

(51) Int. Cl. C08F 14/22; C08K 5/19; C08K 5/41

(52) U.S. Cl. CPC C08F 14/22; C08K 5/19; C08K 5/41

(57) ABSTRACT

This invention provides a composition, an article comprising the composition and a method of making the article. The composition comprises fluorinated polymer, quaternary ammonium salt and crosslink promoter. The article has high transparency and a Maximum Continuous Service Temperature above the melting point of the fluorinated polymer.

### FIELD OF THE INVENTION

The invention provides a composition, an article comprising the composition and a method of making the article. The composition comprises fluorinated polymer, quaternary ammonium salt and crosslink promoter. The article has high transparency and a Maximum Continuous Service Temperature above the melting point of the fluorinated polymer.

### BACKGROUND

Crosslinked (polyvinylidene fluoride) PVDF polymers are commonly used in wire and cable application because of high temperature requirements. Good examples include the use of crosslinked PVDF polymers is as insulation for automotive cables or as heat shrink tubing. Crosslinked PVDF polymers are commonly used under automotive hoods because of the higher temperature requirement and as such, need to provide resistance to automotive fluids and resistance to melt flow at elevated temperatures. In certain cases, applications require the ability to visibly see through the crosslinked PVDF polymer to allow inspection or identification of the marks below the PVDF jacket.

There are several known ways in the art to increase the transparency of PVDF polymers. A common method of improving transparency is by copolymerizing vinylidene fluoride with a comonomer. The presence of the copolymer reduces crystallinity resulting in higher transparency. Although transparency is increased by introducing high levels of comonomer, the level of transparency gained is still below that needed for the applications. Another method of improving transparency is by introducing additives such as acrylic polymers or plasticizers.

The addition of acrylic polymers in PVDF is a known means of improving transparency.

Polymethylmethacrylate (“PMMA”) resins are one of the few polymers that is completely miscible in PVDF resins and can be blended with PVDF resins at any ratio. For PMMA to provide the necessary level of transparency, it needs to be added at relatively larger quantity normally with the minimum acrylic level above 10% by wt. The addition of PMMA resin to PVDF is not commonly practiced due to significant property losses associated with its addition. As an example, the addition of PMMA to PVDF resin sufficient to provide useful transparency results in drop in tensile stress, and significant drop in flame and smoke, both are considered to be negative effects and not desirable for the wire and cable applications. The addition of PMMA also reduces the melting point and crystallinity of the PVDF resin reducing its ability to survive in an under automotive hood environment. Chemical resistance of the PVDF polymer are known to be extremely good, meaning that mechanical property retention of 80% or more of the unaged value after exposure to acid, base (pH less than 12), and organic solvents and hydrocarbon solvent. However, addition of acrylic polymer results in significant reduction in the chemical resistance of PVDF polymer (measure by mechanical property loss). Most importantly, addition of acrylic polymer results in loss of V0 property (rating per UL94) which is a measure of the flame and smoke propagation in the event of fire, a property that is inherent to PVDF polymer. V0 rating is very important in wire and cable applications. Furthermore, addition of acrylic polymer may also reduce the crosslinking efficiency and reduces the creep resistance for the composite.

The addition of a plasticizer can also be used as a means of improving clarity (transparency) of the PVDF polymer and also provides some favorable characteristics such as a reduction in flexural modulus and improved flexibility, both considered useful in many wire and cable applications. One of the primary problems with plasticizers is that they are low molecular weight mobile species and, as such, are not considered permanent in the composition. Plasticizers tend to migrate to the surface of the polymer which eventually leads to property changes including flexibility, crack resistance, low color retention and transparency. Most importantly, the addition of plasticizer negatively interferes with the ebeam crosslinking process. The plasticizer competes in the crosslinking reaction in a manner that interferes with increasing the molecular weight of the fluoropolymer as these crosslinks form. This competing reaction reduces the number of effective cross links between fluoropolymer chains thereby reducing crosslinking efficiency. To compensate for the presence of plasticizers, significantly higher levels of ebeam exposure are needed to effectively crosslink the PVDF polymer. Unfortunately, high ebeam exposure introduces unacceptable property changes associated with disruption of polymer crystallinity (lower melting point) and chain scission (lower mechanical properties). In summary, the presence of plasticizer negatively affects crosslinking efficiently and also does not provide transparency longer term.

The problems producing a transparent PVDF resin able to retain needed physical and mechanical properties after ebeam crosslinking are resolved by practicing this invention. The addition of a quaternary ammonium salts can improve transparency and results in a slight reduction in modulus without any significant change in percentage crystallinity. This invention uses a quaternary ammonium salt and cross linker to provide a crosslinked resin having clarity. Unexpectedly, unlike other methods of improving transparency in PVDF resins, the invention is able to produce a clear material that remains clear after crosslinking and is able to retain other desirable properties for many applications, including wire and cable applications. The desirable properties for wire and cable may include low modulus, higher melt temperature, smoke and flame V0 rating, chemical resistance, crosslinkability, tensile strength, flexibility and elongation. The chemical resistance may include resistance to fluids such as to automotive fluids. Automotive fluids can include break fluid, transmission fluid, coolant, washing fluids, greases, engine oil and of course various fuels.

Desirable properties such as chemical resistance and resistance to burning are retained after crosslinking when using this invention unlike other means of improving PVDF transparency such as thru addition of plasticizers or acrylic polymer. The crosslinked product of this invention provides a unique combination not seen before for PVDF polymer.

U.S. Pat. No. 3,269,862 teaches the use of TAIC crosslinked promoter to increase the crosslinking of a PVDF polymer.

U.S. Pat. No. 6,610,766 teaches the use of an alkyl quaternary ammonium sulfate, or sulfite, with PVDF to increase the electrical resistivity of the polymer. They also describe an increase in the transparency of PVDF. Their examples and especially FIG. 4 shows the melt temperature decreasing with increased amount of ammonium salt added.

WO2020137108A1 and WO20137116A1 further teach the use of an alkyl quaternary ammonium sulfate, or sulfite, with PVDF. The compositions achieve good transparency and suppresses yellowing in thick parts, thanks to a concentration of alkali metal in the polyvinylidene fluoride resin composition of 60 ppm or less, a concentration of hydrogen fluoride in the polyvinylidene fluoride of 5 ppm or less, and/or a proportion of heterogeneous bonding in the polyvinylidene fluoride of 4% or higher. There is no mention of the melt temperature of the PVDF increasing with the addition of the quaternary ammonium salt.

WO2007145668 teaches the use of onium salts with PVDF. The compositions are annealed at high temperatures and/or the onium salts are modified with nanoclays, to achieve a composition with piezoelectric properties, high melt temperature, and low flexural modulus. There is no mention of the onium salts imparting transparency to the PVDF composition.

WO15048697 teaches the use of ammonium and phosphonium salts with PVDF that contains residual surfactant having acid end-groups. The salt is said to react with the acid end groups and improve the color stability the product after melt processing. A preferred family of salts are quaternary ammonium halides. There is no mention on the effect of the salts on transparency, melt temperature, or modulus of the polymer.

When transparent PVDF polymer compositions or articles are crosslinked via ebeam to increase the Maximum Continuous Service temperature the properties can be negatively affected, for example they become less transparent/hazy. This invention solves this problem by maintaining useful properties like clarity, flexural modulus, flame and smoke resistance, chemical resistance, and crosslinking efficiency.

Using the invention, a transparent PVDF article (measure by low haze) that has a Maximum Continuous Service temperature, greater than or equal to 150° C., greater than or equal to 175° C., and up to 200° C. and retains useful properties can be obtained independent of the starting melting point of the resin. As an example, a PVDF copolymer (not crosslinked) having a melting point of 145° C. and a service temperature of 130° C. and relatively high haze can be made clear, retain all original properties and have a continuous use temperature above 150 C, or above 155° C. or, above 165 C by using this invention. The invention solves the problem by crosslinking, using irradiation, the PVDF composition in the formed article, containing cross-link promotor and quaternary ammonium salt, in presence.

### BRIEF DESCRIPTION OF THE INVENTION

The invention provides for a composition comprising PVDF polymer, quaternary ammonium salt (TBAHS) and crosslink promotor. The PVDF polymer is either a homopolymer or a homogeneous copolymer also described as a random copolymer. The amount of quaternary ammonium salt is at least 0.01 to less than 2.5 wt % based on weight of the PVDF polymer and the amount of crosslink promotor is at least 0.01 to less than 5 wt % based on weight of the PVDF polymer.

The invention also provides an article using the inventive composition having a Maximum Continuous Service Temperature above the melting point of the PVDF polymer and is transparent with haze less than 40% for 1 mm thickness. A higher Maximum Continuous Service Temperature is achieved by crosslinking the article by irradiation in presence of cross-linked promotor and quaternary ammonium salt. This transparent PVDF technology is able to achieve transparency (lower haze), useful physical properties, and retain flame and smoke properties after e-beam radiation without negatively interfering with ebeam crosslinking.

The crossing linking of a PVDF containing a quaternary ammonium salt and a crosslinking promotor provides for an article that exhibits transparency as measured by low haze and a Maximum Continuous Service Temperature above the melting point of the uncrosslinked PVDF. In general, the Maximum Continuous Service temperature of PVDF that is not crosslinked is approximately 15° C. below its melting point. For PVDF homopolymer having a melting point of 165° C., the Maximum Continuous Service temperature is about 150° C. Using the invention, a transparent PVDF article (measure by low haze) that has a Maximum Continuous Service Temperature, greater than or equal to 150° C., or greater than or equal to 165 C or greater than or equal to 175 C, and as high as 200° C. and retains useful properties can be obtained independent of the starting melting point of the resin. In contrast, the article of the invention can be use above 150° C., preferably above 165 C and more preferably above 175 C and in some embodiments up to 220° C. This unique combination does not negatively affect other properties that would limit the use of polymer. For example, flame and smoke, and mechanicals properties are substantially maintained.

The quaternary ammonium salt able to create transparent Kynar® PVDF resins belong to the family of tetrabutyl quaternary ammonium salts such as Tetrabutylammonium hydrogen sulfate (TBAHS).

Transparency sometimes described as having “see-though” capability allows visual inspection of the connections and read label through the PVDF easily at such high temperatures. The combination of higher Maximum Continuous service temperature and clarity is unique for some applications like wire and cable, automotive tubing applications.

### ASPECTS THE INVENTION

One aspect of the invention provides for a composition comprising PVDF polymer, quaternary ammonium salt and crosslink promotor, wherein the PVDF polymer is either a homopolymer or a homogeneous copolymer, wherein the amount of quaternary ammonium salt is at least 0.1 to less than 5 wt %, preferably less than 3 wt %, and more preferably less than 2.5 wt % based on weight of the PVDF polymer and the amount of crosslink promotor is between 0.01 wt %, to less than 5 wt %, preferably less than 4 wt % and more preferably less than 3.5 wt % based on weight of the PVDF polymer.

The second aspect of the invention provides The composition of aspect one wherein the quaternary ammonium salt is a tetrabutyl quaternary ammonium salt.

The third aspect provides for any one or more of the previous aspects wherein the PVDF polymer comprises a homopolymer.

The forth aspect provides for any combination of any of the previous aspects wherein the PVDF polymer comprises a copolymer having from 1 to 20 wt % comonomer unit.

The firth aspect provides for the forth aspect wherein comonomer unit is HFP.

The sixth provides for any combination of any of the previous aspects wherein said crosslinking promoter is selected from the group consisting of cis-1,2-polybutadiene (1,2-BR); diallyl terephthalate (DATP); triallyl cyanurate (TAC); and triallyl isocyanurate (TAIC).

The seventh aspect provides for any combination of any of the previous aspects wherein said crosslinking promoter comprises TAIC.

The eighth aspect provides for any combination of any of the previous aspects wherein the quaternary ammonium salt comprises at least one of alkyl quaternary ammonium salts, or aryl containing quaternary ammonium salts.

The ninth aspect provides for any combination of any of the previous aspects wherein the quaternary ammonium salt comprises at least one of tetrabutyl ammonium bisulfate, tetrabutylammonium tetrafluorobate or tetrabutylammonium hexafluorophosphate.

The tenth aspect provides for any combination of any of the previous aspects wherein the quaternary ammonium salt comprises tetrabutyl ammonium hydrogen sulfate (TBAHS).

The eleventh aspect provides for a method of making an article wherein the method comprises
a) providing the composition of any combination of any of the previous aspects,
b) melt processing said composition to form a shape,
c) exposing the shape to ebeam radiation sufficient to cross link the composition resulting in an article.

The twelfth aspect provides for the eleventh aspect wherein the amount of radiation is from 3 to 15 rads.

The thirteenth aspect provides for an article comprising crosslinked PVDF homopolymer or copolymer, quaternary ammonium salt and crosslink promotor wherein said article has a maximum continuous service temperature of at least 150 C, and has transparency as measured by haze (ASTM D1003) of less than 40% for 1 mm thick article.

The fourteenth aspect provide for the thirteenth aspect wherein the quaternary ammonium salt comprises TBAHS.

The fifthteenth aspect provides for the thirteenth aspect or fourteenth aspect wherein the crosslink promotor comprises TAIC.

The sixteenth aspect provides for any combination of the thirteenth aspect, fourteenth aspect or fifthteenth aspect, wherein the maximum continuous service temperature is at least 165 C.

The seventhteenth aspect provides for any combination of the thirteenth aspect, fourteenth aspect or fifthteenth aspect, wherein the maximum continuous service temperature is at least 175 C.

The eighteenth aspect provides for any combination of the thirteenth aspect, fourteenth aspect or fifthteenth aspect, wherein the maximum continuous service temperature of between at least 165 C and 220 C.

### DESCRIPTION OF THE INVENTION

The references cited in this application are incorporated herein by reference.

Percentages, as used herein are weight percentages, unless noted otherwise, and molecular weights are weight average molecular weights, unless otherwise stated. Melt viscosity (MV) is measured at 230° C. at 100 sec⁻¹ using ASTM D-3835.

“Homopolymer” is used to mean a polymer having a single monomer unit. “Copolymer” is used to mean a polymer having two or more different monomer units. “Polymer” is used to mean both homopolymer and copolymers. For example, as used herein, “PVDF” and “polyvinylidene fluoride” is used to connote both the homopolymer and copolymers, unless specifically noted otherwise. Polymers may be straight chain, branched, star, comb, or any other structure. A polymer described as “homogeneous” is one where it forms a single continuous phase in the solid state. All homopolymers are inherently homogeneous. A homogeneous copolymer of this invention is produced when the comonomer units are statistically randomly distributed along the polymer chain. This can also be referred to as a random copolymer. If the probability of finding a given type monomer residue at a particular point in the chain is equal to the mole fraction of that monomer residue in the chain, then the polymer may be referred to as a homogeneous copolymer. A polymer described as “heterogeneous” is one where it forms two or more phases in the solid state. Often, a heterogeneous polymer is described as having a monomer rich phase and a separate homopolymer rich phase. A heterogeneous copolymer can be produced when some polymer chains contain high levels of comonomer units and other polymer chains contain no comonomer and the two chain types are immicible in each other resulting in phase separation. The polymer of the invention is not heterogeneous. As a way of example, the polymers made according to U.S. Pat. Nos. 6,187,885 and 10,570,230 are considered heterogeneous.

Crosslinking is defined as a bond or a short sequences of bonds that links more than one polymer chain together. A crosslinked polymer will have increase in viscosity depending on amount of crosslinking in the polymer.

Crosslink Promoters are multifunctional and comprised of either small molecules (or oligomers) containing unsaturated pendant groups (multiple vinyl groups), which are very reactive molecules. Addition of a crosslink promoter allows for higher levels of crosslinking at lower levels of e-beam exposure. Crosslink promoters are therefore often added to improve crosslink efficiency.

The service temperature is the temperature of the intended environment of service. As an example, the service temperature described for automotive under the hood applications can be rated as 125° C., 150° C., 175° C., 200° C. and greater depending on the expected temperature in various locations under the hood. Maximum Continuous Service Temperature is the maximum acceptable temperature above which mechanical properties (for example tensile strength, impact strength) of an article significantly degrade, over the reasonable life time of the tested product. The Maximum Continuous Service temperature needs to be the same or higher than the service temperature.

The Maximum Continuous Service Temperature of the cross-linked article is measured by using torsional dynamic mechanical analysis, as referenced in ASTM D4065. A small sinusoidal deformation, 0.1% strain, is applied to a rectangular specimen, 50 mm×12.5 mm×1 mm, with a constant frequency of 1 Hz, while the temperature is ramped in steps from 25 C to 200 C with a heating rate of 2 C/min. The change in shear storage modulus G′, is monitored during the temperature sweep. As long as the storage modulus G′ of the crosslinked article retains at least 30% or more of the value, preferably at least 50% and more preferably at least 70% measured at the melting point (melting point of the non crosslinked PVDF) then it is under the Maximum Continuous Service Temperature. If the modulus goes below 30% as measured at the melting, the PVDF has hit the Maximum Continuous Service Temperature. For purposes of this invention the Maximum Continuous Service Temperature is no more than 220 C.

The crosslinked article retains mechanical properties with an extended service temperature.

In general, the Maximum Continuous Service Temperature assigned to PVDF resins (not crosslinked) is approximately 15° C. below its melting point. For PVDF homopolymers having a melting point of 165° C., Maximum Continuous Service Temperature assigned is 150° C. For PVDF copolymers having lower melting points, a lower Maximum Continuous Service Temperature would be assigned. For purposes of this invention the Maximum Continuous Service Temperature is no more than 220 C.

Polymers need to provide a Maximum Continuous Service temperature, the same or higher than the expected service temperature of a particular application. The Maximum Continuous Service temperature of an uncrosslinked polymer is below its melting point because as an article reaches the melting point of the polymer the polymer will flow and deform the article will not maintain its shape. In the present invention, the article made from the inventive polymer composition can be used above the melting point of the uncrosslinked polymer

E-Beam Radiation is a known technique used to impart energy to induce crosslinking between polymer chains.

### PVDF Polymers

PVDF homopolymers or copolymers are used in the invention.

The term PVDF copolymers denotes copolymers of vinylidene fluoride (VDF) containing one or more other fluorinated comonomers or non-fluorinated comonomers, preferably fluorinated. The PVDF copolymers of the invention are those in which vinylidene fluoride units comprise greater than 80 wt % of the total weight of all the monomer units in the polymer, more preferably comprise greater than 82 wt % of the total weight of the units, and most preferably comprise greater than 85 wt % of the total weight of the units. The fluorinated comonomer(s) preferably comprises at least 0.5 wt %, preferably at least 1 wt %, more preferably at least 4 wt % of the PVDF copolymer. The fluorinated comonomer(s) are preferably from 0.5 wt % to 20 wt %, more preferably from 1 wt % to 18 wt %.

Fluorinated comonomers are chosen from compounds containing a vinyl group capable of opening in order to be polymerized and that contains, directly attached to this vinyl group, at least one fluorine atom, at least one fluoroalkyl group or at least one fluoroalkoxy group except VDF as it is already present in the PVDF copolymer. Examples of fluorinated comonomers include, but are not limited to vinyl fluoride; trifluoroethylene (VF3); chlorotrifluoroethylene (CTFE); 1,2-difluoroethylene; tetrafluoroethylene (TFE); hexafluoropropylene (HFP); 2,3,3,3-tetrafluoropropylene; 1,3,3,3-tetrafluoropropylene; 3,3,3-trifluoropropylene; perfluoro (alkyl vinyl) ethers, such as perfluoro(methyl vinyl) ether (PMVE), perfluoro (ethyl vinyl) ether (PEVE) and perfluoro (propyl vinyl) ether (PPVE); perfluoro (1,3-dioxole); perfluoro (2,2-dimethyl-1,3-dioxole) (PDD). Preferred PVDF copolymers include copolymers of copolymers of VDF and HFP, copolymers of VDF and 2,3,3,3-tetrafluoropropylene, copolymers of VDF and 3,3,3-trifluoropropylene, copolymers comprising VDF, HFP, and TFE.

The PVDF copolymer can be a copolymer of VDF and HFP. In one embodiment, the copolymer has from at least 1 wt % up to 20 wt %, preferably up to 18 wt %, by weight of hexafluoropropene (HFP) units.

The PVDF copolymer can have at least 80 wt %, preferably at least 82 wt %, by weight of VDF units.

The PVDF copolymer for use in the invention has a high molecular weight. By high molecular weight, as used herein is meant having a melt viscosity of greater than 1.0 kilopoise, preferably greater than 5 kilopoise, more preferably greater than 10 kilopoise, according to ASTM method D-3835 measured at 230° C. and 100 sec⁻¹.

The PVDF copolymer used in the invention is generally prepared by means known in the art, using aqueous free-radical emulsion polymerization—although suspension, solution and supercritical CO₂ polymerization processes may also be used.

In a general emulsion polymerization process, a reactor is charged with deionized water, water-soluble surfactant capable of emulsifying the reactant mass during polymerization and optional paraffin wax antifoulant. In some polymerizations, no surfactant is used. The mixture is stirred and deoxygenated. A predetermined amount of chain transfer agent, CTA, is then introduced into the reactor, the reactor temperature raised to the desired level and vinylidene fluoride and optionally one or more comonomers are fed into the reactor. Once the initial charge of vinylidene fluoride and optional comonomers is introduced and the pressure in the reactor has reached the desired level, an initiator emulsion or solution is introduced to start the polymerization reaction. The temperature of the reaction can vary depending on the characteristics of the initiator used and one of skill in the art will know how to do so. Typically, the temperature will be from about 30° to 150° C., preferably from about 60° to 120° C. Once the desired amount of polymer has been reached in the reactor, the monomer feed will be stopped, but initiator feed is optionally continued to consume residual monomer. Residual gases (containing unreacted monomers) are vented and the latex recovered from the reactor.

The surfactant used in the polymerization are non-fluorosurfactants known in the art to be useful in PVDF emulsion polymerization. The PVDF polymer emulsion of the invention is fluorosurfactant free, with no fluorosurfactants being used in any part of the polymerization. The surfactant used in the polymerization also do not contain any acid groups, as such groups have been showed to have poor interaction with the quaternary organic salts of the invention, and prevents the desired property improvement for the PVDF polymer. Non-fluorinated, non-acid containing surfactants useful in the PVDF polymerization of this invention could be both ionic and non-ionic in nature including, but are not limited to sodium alkyl sulfate, sodium aryl sulfate, sodium alkyl sulfonate, sodium aryl sulfonate, polyvinyl sulfonate, polyethylene glycol and/or polypropylene glycol and the block copolymers thereof, and siloxane-based surfactants. In some embodiments, the emulsion polymerization is surfactant-free.

The PVDF used in the invention can be latex form to mix the additive and crosslink promoter or it may be first dried to a powder by means known in the art, such as, but not limited to, spray drying, freeze-drying, coagulating, and drum drying the followed by adding the additive and TAIC to mix.

In some embodiments, copolymers of VDF and HFP are used. In some embodiments homopolymers of VDF are used.

It is preferred that no other fluorinated molecules are present in the composition except the fluorinated monomer units in the PVDF polymer.

### Quaternary Ammonium Salt

The quaternary ammonium salt acts as a nucleating additive for the PVDF.

The Quaternary ammonium salt can be made into a masterbatch with a concentration of up to 15 wt % Quaternary ammonium salt in a carrier resin. This masterbatch would be added to the PVDF to obtain a final Quaternary ammonium salt concentration of 5% or less in the PVDF that is melt processed into the article. In the present application, the term “masterbatch” refers to a composition comprised of a Quaternary ammonium salt pre-dispersed in a carrier polymer. The term “carrier polymer” describes a primary component of a masterbatch used to contain a Quaternary ammonium salt. The carrier polymer may be or comprise the same polymer composition to be extruded or otherwise melt processed into an article. Alternatively, the carrier polymer may be or comprise a different polymer composition which does not adversely affect the melt processing behavior of the PVDF to be shaped into an article. In the present application, the polymer composition to be extruded, namely matrix polymer comprises PVDF.

Quaternary ammonium salt is used in an amount of from 0.1-5 wt % based on the weight of PVDF that will be melt process into an article. Quaternary ammonium salts contain a quaternary ammonium cation center that forms four covalent bonds, each bond is to an alkyl group. Examples of quaternary ammonium salts include alkyl ammonium salts, such as tetrabutyl ammonium bisulfate, tetrabutylammonium tetrafluorobate and tetrabutylammonium hexafluorophosphate.

There can be one or more quaternary ammonium salts present in the PVDF. The total amount of quaternary ammonium salt in the present invention can be at least 0.1 and no more than 2.5% by weight based on the total weight of PVDF polymer. The amount of any one quaternary organic salt can be from 0.1-2%, preferably from 0.02 to 1.5%. The amount of quaternary organic salt can be from 0.2 to 2% by weight based on the weight of PVDF.

### Cross-Link Promotor

The addition of a crosslink promoter provides increased crosslinking efficiency and allows for higher levels of crosslinking at lower levels of e-beam exposure. In most cases, the addition of a crosslink promoter allows the effective crosslinking e-beam dose to be reduced significantly, and in so doing, helps to improve physical properties (and reduces negative property changes). The ability to lower the effective e-beam dose for effective crosslinking is considered useful for improving overall performance of the polymer.

The composition comprises one or more cross link promoters.

The crosslinking promoters used in the invention include organic substances containing at least one or more groups selected from a maleimido group, a (methyl) acrylate group, an allyl group, or polymers containing more than 50% of vinyl. Examples of commercially available crosslinking promoters include: 1,2-polybutadiene cis-1,2-polybutadiene (1,2-BR); diallyl terephthalate (DATP); divinylbenzene (DVB); triallyl cyanurate (TAC); and/or triallyl cyanurate (TAP); triallyl isocyanurate (TAIC); or derivatives thereof. Preferably triallyl isocyanurate; cis-1,2-polybutadiene (1,2-BR); diallyl terephthalate (DATP); and triallyl cyanurate (TAC. The preferred cross link promoter used for the invention is TAIC.

There can be one or more crosslink promotors present. The total amount of cross link promotor in the present invention will be at least 0.01 and no more than 5 wt % based on the weight of PVDF. The amount of cross link promoter can be from 0.01-5 wt %, preferably from 0.02 to 3 wt %, more preferably from 0.02 to 2 wt % based on weight of PVDF.

### Method of Making the Article.

To obtain the benefit of the invention. The composition comprising PVDF polymer, quaternary organic salt and crosslink promoter, is melt processed into a desired article, the shaped article is then exposed to ebeam radiation resulting in crosslinking of the PVDF polymer in the article. The amount of ebeam radiation is between at least 3 Mrads and upto 20 Mrads, preferably 15 Mrads or less, more preferably 13 rads or less.

The resulting article exhibits
a) a maximum Maximum Continuous Service temperature above the melting point of the PVDF polymer (prior to cross linking),
b) high transparency
   than an article lacking the combination of organic salt and crosslink promoter when exposed to the same ebeam radiation amount.

The modify resin preferable will have flame and smoke rating with no more than 10% difference to unmodified resin.

This invention works with homogeneous PVDF resin either homopolymer or copolymer. This invention does not work well with heterogeneous PVDF resin or PVDF resins containing HFP above 20 wt % based on total monomer units. Heterogeneous polymers are described in U.S. Pat. Nos. 6,187,885 and 10,570,230. The addition of cross-linked promotor improves crosslinking efficiency and thermal stability at temperatures at and above the melting point of the polymer prior to cross linking above 150° C., preferably above 175° C. The melting point of the polymer is defined by DSC as endothermic peak on heating using ASTM D3418.

### EXAMPLES

Preparation of samples: PVDF resins were compounded on ZSK30 mm twin screw extruder with quaternary organic salt TBAHS (powder) and TAIC crosslink promoter. The process temperature was 220° C. or lower.

Compression Molding: The 1 mm compression molded plaques (2×3 inches) were prepared at 210° C. for 10 minutes at 10,000 lbf pressure.

E-Beam Irradiation: The radiation dose was set at 2.5 Mrads per exposure with higher levels of radiation achieved by exposing samples multiple times at 2.5 Mrads. As examples, to achieve 5.0 Mrads exposure, samples were ebeamed twice (once per side), and to achieve 10.0 Mrads exposure, samples were ebeamed four times (twice per side).

Injection Molding: The resin without TAIC were only injection molded into Type 1 ASTM tensile bars for testing because those once are only available in large enough quantity. The injection molding was done on the Sumitomo DUZ 75 ton machine.

The haze for the samples were measured before and after irradiation using the BYK Haze Gard Plus unit on the 1 mm thick compression molded plaques. Results from this analysis were consistent with visual observations made earlier of these same samples. Haze-gard plus conforms to the standards ASTM D-1003.

Crosslinking Efficiency: Cross-linking efficiency was evaluated by small amplitude oscillatory shear rheology at 230 C. Circular 1 inch diameter, 1 mm thick plaque was loaded between two parallel plates heated to 230 C. A small sinusoidal deformation was applied to the melt while the viscosity and moduli were recorded at different angular frequencies. The increase of the zero-shear viscosity and storage modulus after irradiation indicates that the polymer has been cross-linked. The sensitivity of the rheological method allows to compare subtle differences between the samples. Higher crosslink efficiency was defined as higher viscosity shift at equivalent ebeam exposures.

### Example 1

1 mm thick plaque was used for optical measurement. The higher the haze reduction the transparent the product.

Parallel Plate rheology tests were performed on the PVDF co-polymer resins after exposure to zero or 10 Mrads ebeam. The complex viscosity measured at angular frequency of 0.01 rad/s and 230 C was used in the table to difference crosslinking efficiency. Higher the complex viscosity indicates higher crosslinking in the resin.

| | KynarFlex ® | | | Percentage |
|---|---|---|---|---|
| | 2800-00 with | Radiation | Complex | Reduction |
| | indicated | Level | Viscosity | in Haze (%) |
| | additive | (Mrads) | (KPa · s) | After Radiation |
| Control | N/A | 0 | 170 | — |
| Control | N/A | 10 | 3172 | 0 |
| Control | 0.5% TBAHS | 0 | 134 | 91.2 |
| Control | 0.5% TBAHS | 10 | 1717 | 91.4 |
| Control | 3% TAIC | 0 | 129 | 3.0 |
| Control | 3% TAIC | 10 | 25343 | 3.1 |
| Control | 0.5% TBAHS + | 0 | 123 | 86.3 |
| | 3% TAIC | | | |
| Inventive | 0.5% TBAHS + | 10 | 16649 | 88.8 |
| example | 3% TAIC | | | |

The higher complex viscosity means higher crosslinking and higher haze reduction means more transparent the sample. As shown in table, the control co-polymer resin after radiation shows increase in complex viscosity indicating crosslinking in sample but the haze remain unchanged. On the other hand the addition of TBAHS salt improves the haze reduction but suffers from reduced crosslinking. Similar the addition of TAIC crosslinking promotes boost the crosslinking in the resin but does not help much in haze reduction. The combination of the TBAHS and the TAIC provides medium product where with improvement in complex viscosity (crosslinking) and also haze reduction (transparence).

This example shows that both the quaternary ammonium salt and the crosslink promoter are need to obtained a high complex viscosity and a large reduction in haze.

### Example 2

1 mm thick plaque was used for optical measurement. The higher the haze reduction the more transparent the product.

Parallel Plate rheology tests were performed on PVDF homo-polymer resins after exposure to zero or 10 Mrads ebeam. The complex viscosity at angular frequency of 0.01 rad/s was used in the table to difference crosslinking efficiency Higher the complex viscosity higher the crosslinking in the resin

| | | | | Percentage | Percentage |
|---|---|---|---|---|---|
| | | Radiation | Complex | Increase in | Reduction in |
| | | Level | Viscosity | Complex | Haze (%) After |
| | Kynar ® 740 | (Mrads) | (KPa · s) | Viscosity (%) | Radiation |
| Control | N/A | 0 | 63 | — | — |
| Control | N/A | 10 | 379 | 502 | 0 |
| Control | 1.5% TBAHS | 0 | 46 | −27 | 70.3 |
| Control | 1.5% TBAHS | 10 | 63 | 0 | 72.0 |
| Control | 3% TAIC | 0 | 52 | −18 | 0 |
| Control | 3% TAIC | 10 | 19805 | 31337 | 0 |
| Control | 1.5% TBAHS + 3% TAIC | 0 | 37 | −41 | 68.3 |
| Inventive | 1.5% TBAHS + 3% TAIC | 10 | 4858 | 7611 | 70.2 |
| example | | | | | |
| | | | | Percentage | Percentage |
| | | | Complex | Increase in | Reduction in |
| | | Radiation | Viscosity | Complex | Haze (%) After |
| | Kynar ® 460 | Level | (KPa · s) | Viscosity (%) | Radiation |
| Control | N/A | 0 | 1000 | — | — |
| Control | N/A | 10 | 4136 | 314 | 0 |
| Control | 1.5% TBAHS | 0 | 879 | −12 | 74.9 |
| Control | 1.5% TBAHS | 10 | 1769 | 77 | 75.6 |
| Control | 3% TAIC | 0 | 641 | −36 | 0.3 |
| Control | 3% TAIC | 10 | 20617 | 1962 | 1.1 |
| Control | 1.5% TBAHS + 3% TAIC | 0 | 668 | −33 | 86.2 |
| Inventive | 1.5% TBAHS + 3% TAIC | 10 | 13836 | 1284 | 87.0 |
| example | | | | | |

Similar to co-polymer resin, the control homo-polymer PVDF resins after radiation shows increase in complex viscosity indicating crosslinking in sample but the haze remain unchanged. On the other hand the addition of TBAHS salt improves the haze reduction but suffers from reduced crosslinking. Similar the addition of TAIC crosslinking promotes the crosslinking in the resin but does not help much in haze reduction. The combination of the TBAHS and the TAIC provides a product with improvement in complex viscosity (crosslinking) and also haze reduction (transparence).

### Example 3

The DSC was performed from −20° C. to 210° C. using a 10° C./min heating rate to confirm expected changes to melting temperature measured at the second heat.

Radiation Dose

| Sample | None | 10 Mrads |
|---|---|---|
| Kynar ® 740 | 169.7 | 167.9 |
| Kynar ® 740 with 1.5% TBAHS | 175.4 | 173.6 |
| Kynar ® 720 | 174.4 | — |
| Kynar ® 720 with 30% PMMA | 168.9 | — |
| Kynar SuperFlex ® 2500-50 | | |
| Kynar SuperFlex ® 2500-50 + 2.5% DBS | | |

The addition of the TBAHS salt increased the Tm by some degrees as compared to other clarifying additive which drops. The table summarized the Tm (melt point temperature) of the various material. The material with tetrabutyl quaternary ammonium salt and crosslinked promotor, after radiation can be use in application above the melt temperature mentioned in above table.

1. A composition comprising PVDF polymer, quaternary ammonium salt and crosslink promotor,
wherein the PVDF polymer is either a homopolymer or a homogeneous copolymer,
wherein the amount of quaternary ammonium salt is at least 0.1 to less than 5 wt %, based on weight of the PVDF polymer and the amount of crosslink promotor is between 0.01 wt %, to less than 5 wt %, based on weight of the PVDF polymer.

2. The composition according to claim 1 wherein the quaternary ammonium salt is a tetrabutyl quaternary ammonium salt.

3. The composition according to claim 1, wherein PVDF polymer comprises a homopolymer.

4. The composition according to claim 1, wherein PVDF polymer comprises a copolymer having from 1 to 20 wt % comonomer unit.

5. The composition according to claim 4, wherein comonomer unit is HFP.

6. The composition according to claim 1, wherein said crosslinking promoter is selected from the group consisting of cis-1,2-polybutadiene (1,2-BR); diallyl terephthalate (DATP); triallyl cyanurate (TAC); and triallyl isocyanurate (TAIC).

7. The composition according to claim 1, wherein said crosslinking promoter comprises TAIC.

8. The composition according to claim 1, wherein the quaternary ammonium salt comprises at least one of alkyl quaternary ammonium salts, or aryl containing quaternary ammonium salts.

9. The composition according to claim 1, wherein the quaternary ammonium salt comprises at least one of tetrabutyl ammonium bisulfate, tetrabutylammonium tetrafluorobate or tetrabutylammonium hexafluorophosphate.

10. The composition according to claim 1, wherein the quaternary ammonium salt comprises tetrabutyl ammonium hydrogen sulfate (TBAHS).

11. A method of making an article wherein the method comprises
a) providing the composition of claim 1,
b) melt processing said composition to form a shape,
c) exposing the shape to ebeam radiation sufficient to cross link the composition resulting in an article.

12. The method of claim 11, wherein the amount of radiation is from 3 to 15 rads.

13. An article comprising a crosslinked PVDF homopolymer or a crosslinked homogeneous PVDF copolymer, quaternary ammonium salt and crosslink promotor wherein said article has a maximum continuous service temperature of at least 150 C, and has transparency as measured by haze (ASTM D1003) of less than 40% for 1 mm thick article.

14. The article of claim 13, wherein the quaternary ammonium salt comprises TBAHS.

15. The article of claim 13, wherein the crosslink promotor comprises TAIC.

16. The article of claim 13, wherein the maximum continuous service temperature is at least 165° C.

17. The article of claim 13, wherein the maximum continuous service temperature is at least 175° C.

18. The article of claim 13, wherein the article has a maximum continuous service temperature of between at least 165° C. and 220° C.
